(19) United States
(12) Patent Application Publication
(10) Pub. No.: US 2009/0167085 A1
(43) Pub. Date: Jul. 2, 2009

(54) Voltage Detection System for a Range

(76) Inventors: Julia Fonseca, Louisville, KY (US); Robert Marten Bultman, Louisville, KY (US); Bobby Hayes, Smithfield, KY (US)

Correspondence Address: General Electric Company;GE Global Patent Operation, PO Box 861, 2 Corporate Drive, Suite 648, Shelton, CT, 06484, US

(21) Appl. No.: 11/966,047

(22) Filed: Dec. 28, 2007

(51) Int. Cl. G05F 5/02

(52) U.S. Cl. 307/32

(57) ABSTRACT

An appliance is provided with an improved power management system for controlling the total amount of current provided to at least a first load device of the appliance. The power management system is comprised of a microprocessor, an alternating current voltage source, a voltage regulating circuit, a clamping circuit, at least one load device, and a MOC and a triac for each of the at least two load devices. The clamping circuit outputs a fixed voltage of 5.7 volts during the positive portion of the ac cycle and a fixed voltage of −0.7 volts during the negative portion of the ac cycle. The fixed voltages are input to a microprocessor which utilizes these inputs to control the average voltage and the amount of time the current is turned on to each of the at least first and second load devices. A current sensing circuit is used to monitor the current to one of the at least two load devices to provide feedback to the microprocessor so that the microprocessor can adjust the average voltage and current to the at least two load devices so that the total current consumed does not exceed a pre-determined level.

### BACKGROUND OF THE INVENTION

This invention relates to appliances, and more specifically, to a range having a power management system for detecting the source line voltage and adjusting load device currents of the range.

This invention relates generally to electronic power control systems for electrical loads which may be subject to a plurality of different supply voltages or to substantial swings relative to a nominal supply voltage. Cooking performance can be influenced by the line voltage. The standard line voltage for a range is 240 VAC, but there are certain locations where only 208 VAC is supplied on the line. This drop in line voltage can have a negative impact on cooking performance.

In different geographic areas within the U.S. as well as among various countries throughout the world, the nominal supply voltages can differ significantly. Typical nominal RMS supply voltages are 208, 220, 240 volts. In addition, voltages can vary from the nominal supply value. In resistive heating elements such as may be employed in cooking appliances, relatively large output power changes can occur with relatively small changes in input voltages since output power varies with the square of the voltage. Similar changes can occur with non-resistive loads such as electric motors for washing machines, or inverter circuits for induction cooktops.

Rather than design a different control system for each different nominal supply voltage it would be desirable to provide a single cost effective control system for an appliance, for example, which would allow the appliance to be used with any of the various power supplies. To be attractive for such applications the control system should either automatically adapt to the applied voltage, or at least be readily and simply pre-settable to various supply voltages in the factory or during installation. If the range is able to sense that 208 VAC is being supplied on the line, it can use cooking parameters that are specifically tailored to lower voltage (208 VAC) operation. providing uniform cooking settings independent of the line voltage.

In addition, it would be desirable to provide a control system for an appliance which automatically compensates for over-voltage or under-voltage conditions without any apparent difference in performance thereby preventing damage to the appliance, avoiding a potential safety hazard, all without interrupting use and enjoyment of the appliance.

### SUMMARY OF THE INVENTION

In the preferred embodiment of the invention, an improved power management system is provided for controlling the total amount of current provided to at least a first and a second load device of an appliance. The power management system is comprised of a microprocessor, an alternating current voltage source, a voltage regulating circuit, a clamping circuit, a clamping circuit, at least two load devices, and a MOC and a triac for each of the at least two load devices. The clamping circuit outputs a fixed voltage of 5.7 volts during the positive portion of the ac cycle and a fixed voltage of −0.7 volts during the negative portion of the ac cycle. These voltages are input to a microprocessor so the microprocessor knows when the ac voltage crosses the zero threshold from one portion to another. The microprocessor utilizes these inputs to control the amount of time the current is turned on to each of the at least first and second load devices. The current is turned on to each of the at least first and second load devices by an output from the microprocessor provided to the associated MOC which in turn controls the associated triac for turning the current on to the associated load for the amount of time determined by the microprocessor. One of the at least first and second loads has a sensing circuit which monitors the current drawn by the load. A surge or rise in the current drawn will cause an output from the sensing circuit which is input to the microprocessor. The microprocessor will adjust according to pre-programmed instructions the amount of time the current is turned on and hence the average voltage applied to each of the at least first and second loads so that the total current drawn by all of the at least first and second loads does not exceed a pre-determined value. This requires that the microprocessor reduce the average voltage and current provided to the at least second load to account for the increased amount of current used by the first load.

### BRIEF DESCRIPTION OF THE DRAWINGS

FIG. 1 is a perspective view of a portion of a cooktop illustratively embodying the power control system of the present invention;

FIG. 2 is a functional block diagram of the power control circuitry for the cooktop of FIG. 1;

FIG. 3 is a simplified schematic diagram of a control circuit illustratively embodying the power control system of the present invention as embodied in the cooktop of FIG. 1.

### DETAILED DESCRIPTION OF THE INVENTION

In the description to follow, the control arrangement of the present invention is applied in a power control system for an electric cooktop appliance. The invention may, however, be employed to control a variety of other types of electrical loads including but limited to, ranges where a cooking oven is included, a cooktop where the surface burners are exposed, microwave ovens, wall ovens or a combination of electrical appliances. Further, the description herein in conjunction with the cooking appliance is not to be interpreted as limiting the invention to such appliances.

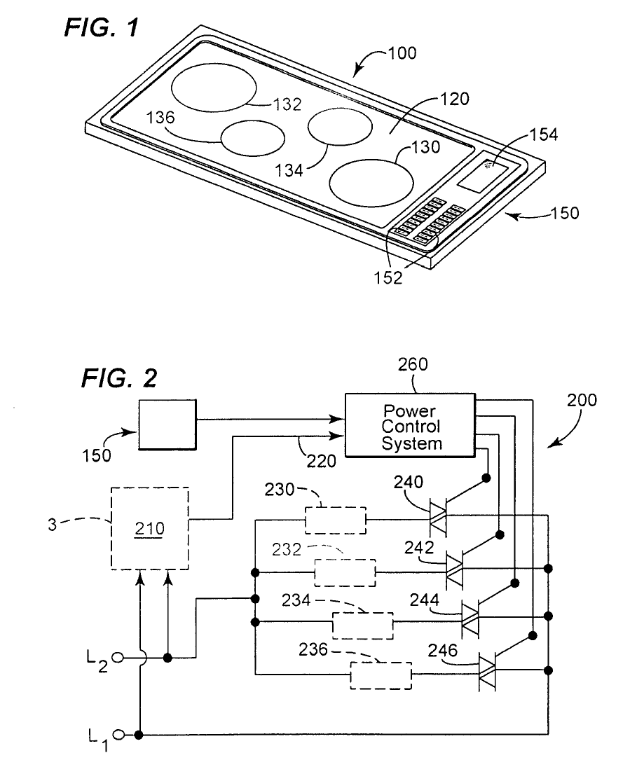

FIG. 1 illustrates a glass-ceramic cooktop appliance designated generally 100. Cooktop appliance 100 has a generally planar glass-ceramic cooking surface 120. Circular patterns 130-136 identify the relative lateral positions of each of four heating units (not shown) located directly underneath surface 120. A control and display panel generally designated 150 includes touch control keys 152 and a display 154 or may include touch keys incorporated into the display 154.

In the description to follow, the designators 230-236 shall be understood to refer to the heating units disposed under patterns 130-136 respectively. Each of heating units 230-236 comprises an open coil electrical resistance element designed when energized at its rated power to radiate primarily in the infrared (1-3 micron) region of the electromagnetic spectrum. Such heating units are known and not described in further detail. Each of heating units 230-236 are designed to operate at 100% of rated power when energized by a specific input voltage, for example of 208 volts RMS.

FIG. 2 illustrates in simplified schematic form, an embodiment of a control arrangement in accordance with the present invention for cooktop 100. Each of four heating units 230-236 is coupled to a standard 60 Hz AC power source, which could be 208 or 240 volts, via power lines L1 and L2 through one of four triacs 240-246 respectively, the heating circuits being connected in parallel arrangement with each other. Triacs 240-246 are conventional thyristors capable of conducting current in either direction irrespective of the voltage polarity across their main terminals when triggered by either a positive or negative voltage applied to the gate terminals.

The power control system 260 controls the power applied to the heating units by controlling the rate at which gate pulses are applied to the triac gate terminals in accordance with power setting selections for each heating unit entered by user actuation of the control and display panel 150.

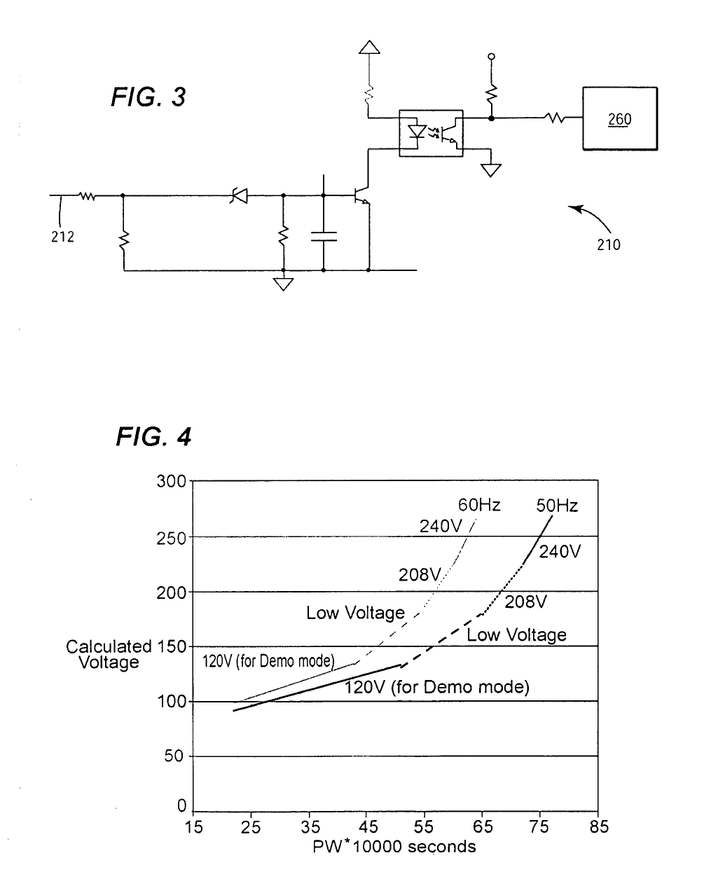

The zerocross circuit 210 shown in FIG. 3 is by way of an example and will be described generally. The zerocross circuit 210 takes a half-wave rectified sinusoidal line voltage as an input 212. The input 212 is sent it through a zener diode that shifts the voltage down by 12V, and outputs a square wave 220 with rising and falling edges that correspond to the zero cross of the sinusoidal wave. The power control system 260 then measures the time that the square wave 220 is low (0V). The time that the square wave 220 is low for a 240 VAC signal will differ from the time that the square wave 220 is at low for a 208 VAC signal. The measured time will be entered into a predetermined linear transfer function to calculate the voltage on the line.

In the illustrative embodiment gate signals are applied to triacs 240-246 to couple power pulses to the heating units. Each pulse is a full cycle of the 60 Hz AC power signal; however, power signals of different frequencies, such as 50 Hz, could be similarly used.

For example the equations used to approximate line voltage at 60 Hz are shown in the following Table 1:

TABLE 1
60 Hz

| | | PW (s) * 10000 | | |
|---|---|---|---|---|
| Range (v) | PW range (s) | range | Eq --> V = m * PW * 10000 + b | Bucket |
| <=135 | <=0.0043 | <=43 | V = 1.7310 * PW * 10000 + 60.1956 | 120 |
| 135 < V < 185 | 0.0043 < PW < 0.0055 | 43.01 < PW < 54.99 | V = 4.2409 * PW * 10000 − 49.2027 | Low voltage |
| 185 <= V <= 223 | 0.0055 <= PW <= 0.0060 | 55 <= PW <= 60 | V = 7.5700 * PW * 10000 − 231.196 | 208 |
| 224 < V | 0.0060 < PW | 60.01 < PW | V = 10.3519 * PW * 10000 − 397.6398 | 240 |

Equations used to approximate line voltage at 50 Hz are shown in Table 2:

TABLE 2
50 Hz

| | | PW (s) * 10000 | | |
|---|---|---|---|---|
| Range (v) | PW range (s) | range | Eq --> V = m * PW * 10000 + b | Bucket |
| <=135 | <=0.0051 | <=51 | V = 1.4401 * PW * 10000 + 60.1987 | 120 |
| 135 < V < 185 | 0.0051 < PW < 0.0065 | 51.01 < PW < 64.99 | V = 3.5273 * PW * 10000 − 48.9065 | Low voltage |
| 185 <= V <= 223 | 0.0065 <= PW <= 0.0072 | 65 <= PW <= 72 | V = 6.1843 * PW * 10000 − 222.9746 | 208 |
| 224 < V | 0.0072 < PW | 72.01 < PW | V = 8.6806 * PW * 10000 − 402.0573 | 240 |

These equations are plotted in FIG. 4. The voltage measurement is then used to select the appropriate cooking parameters.

Power control system 260 is arranged to operate each heating unit at one of a plurality of discrete power levels. These levels are available to adjust the power applied to the heating unit 230-236 such as, for example, to overdrive the heating units when operating in a transient heat up mode to rapidly heat the units to radiant temperature. The power control system uses power pulse repetition to provide an expected heat output at a user specified power setting. Power pulse repetition is known and will not be described in further detail.

While in accordance with the Patent Statutes specific embodiments of the present invention have been illustrated and described herein, it is realized that numerous modifications and changes will occur to those skilled in the art. For example, the invention could also be used in other applications as well, such as power control for induction cooktops or as a motor control in a clothes washing appliance. It is therefore to be understood that the appended claims are intended to cover all such modifications and changes as fall within the true spirit and scope of the invention.

1. A power management system for processing an alternating electrical current supplied to an appliance configured to communicate with a communication network, said system comprising: a zero cross detector circuit to generate an output indicating when the alternating current crosses a zero voltage threshold; at least two load devices; a microprocessor maintaining one or more operational parameters for controlling the performance of said at least two load devices, said microprocessor configured to receive the output from the zero cross detector circuit and to generate an output to control the voltage applied to each of said at least two load devices; and a data port coupled to said microprocessor, said data port configured to be associated with the communication network, wherein said operational parameters maintained by said microprocessor may be changed via said data port; wherein said microprocessor controls the voltage applied to each of said at least two load devices such that the total current consumed by said at least two load devices does not exceed a pre-determined level.

2. The power management system of claim 1, further including at least two load device trigger circuits wherein one load device trigger circuit is associated with one of said at least two load devices for turning the current on to the associated load device.

3. The power management system of claim 1, wherein said microprocessor controls the average voltage applied to each of said at least two load devices with an associated timer which is reset each time said microprocessor detects the alternating current crossing the zero voltage threshold, said microprocessor being pre-programmed with a table of values having an amount of time each timer is on associated with a voltage to be applied to each of the at least two load devices.

4. The power management system of claim 3, wherein said microprocessor receives said input from said at least one sensing circuit and the amount of time each timer associated with each of said at least two load devices is based upon said input according to an amount of time programmed in the table of values associated with a voltage to be applied to all of said at least two load devices such that the total current does not exceed a pre-determined value.

5. The power management system of claim 1, wherein said at least two load devices are electric motors.

6. The power management system of claim 1, wherein said pre-determined level is 12 amps.

7. The power management system of claim 1, wherein said pre-determined level is 12 amps and one of said at least two load devices consumes 10 amps and another of said at least two load devices consumes 2 amps.

8. The power management system of claim 1, wherein said pre-determined level is 12 amps and one of said at least two load devices consumes 9.5 amps and another of said at least two load devices consumes 2.5 amps.

9. The power management system of claim 1, wherein said microcontroller is configured to collect performance data associated with the operation of the appliance.

10. The power management system of claim 9, wherein said microcontroller enables said collected performance data to be output to the communication network via said data port.

11. The power management system of claim 10, wherein said microprocessor.

12. A power management system for processing an alternating electrical current supplied to an appliance and configured to communicate with a communication network, said system comprising: a zero cross detector circuit for generating an output indicating when the alternating current crosses a zero threshold; at least two load devices: a microprocessor maintaining one or more operational parameters for controlling the performance of said at least two load devices, said microprocessor configured to receive the output from the zero cross detector circuit and generating an output; a data port coupled to said microprocessor, said data port configured to be associated with the communication network, wherein said operational parameters maintained by said microprocessor may be changed via said data port; at least one current sensing circuit for sensing the amount of current consumed by one of said at least two load devices and generating an input to said microprocessor corresponding to the amount of current consumed; and at least two load device trigger circuits, wherein one of said at least two load device trigger circuits is associated with one each of said at least two load devices; wherein each of said at least two load device trigger circuits turns on the current to the associated load device upon receiving said output from said microprocessor, said microprocessor generating said output to each of said at least two load device trigger circuits such that a change in the amount of current being consumed by said one load device associated with said at least one current sensing circuit will cause the microprocessor to adjust the output to each of said at least two load devices such that the total current consumed by all of said at least two load devices does not exceed a predetermined amount.

13. The power management system of claim 12, further including at least two load device trigger circuits wherein one load device trigger circuit is associated with one of said at least two load devices for turning the current on to the associated load device.

14. The power management system of claim 12, wherein said microprocessor controls the average voltage applied to each of said at least two load devices with an associated timer which is reset each time said microprocessor detects the alternating current crossing the zero voltage threshold, said microprocessor being pre-programmed with a table of values having an amount of time each timer is on associated with an average voltage to be applied to each of the at least two load devices.

15. The power management system of claim 14, wherein said microprocessor receives said input from said at least one sensing circuit and the amount of time each timer associated with each of said at least two load devices is on is adjusted based upon said input according to an amount of time programmed in the table of values associated with an average voltage such that the total amount of current supplied to all of said at least two load devices does not exceed a pre-determined value.

16. The power management system of claim 12, wherein said microcontroller is configured to collect performance data associated with the operation of the appliance.

17. The power management system of claim 16, wherein said microcontroller enables said collected performance data to be output to the communication network via said via said data port.

18. The power management system of claim 17, wherein said microprocessor enables at least one of said one or more operational parameters to be modified based on said collected performance data output from said data port.

19. A power management system to process an alternating electrical current supplied to a floor care appliance, said system comprising: a zero cross detector circuit configured to generate an output indicating when the alternating current crosses a zero voltage threshold; at least two load devices; and a microprocessor coupled to said at least two load devices and to said zero cross detector circuit, said microprocessor configured to receive the output from the zero cross detector circuit; wherein in response to the receipt of said output generated by said zero cross detector, said microprocessor controls the amount of current supplied to said at least two load devices by monitoring the amount of time the current is turned on to each of said load devices after said zero cross detector generates said output indicating said zero voltage threshold, such that the total current applied to each said at least two load devices does not exceed a pre-determined level.

20. The power management system of claim 19, further including at least two load device trigger circuits wherein one load device trigger circuit is associated with one of said at least two load devices for turning the current on to the associated load device.

21. The power management system of claim 19, wherein said microprocessor controls the current applied to each of said at least two load devices said microprocessor switching the electrical current after a predetermined amount of time so that the amount of current applied to said at least two load devices does not exceed a predetermined value.

22. The power management system of claim 21, wherein said microprocessor is coupled to at least one sensing circuit to sense the current drawn by one of said at least two load devices, such that if said sensing circuit detects a change of current drawn by one of said at least two load devices, said microprocessor adjusts the amount of time the current is turned on to each of the other load devices, such that the total amount of current consumed by said at least two load devices does not exceed a pre-determined value.

23. The power management system of claim 19, wherein said microcontroller is configured to collect performance data associated with the operation of the appliance.

24. The power management system of claim 23, wherein said microcontroller enables said collected performance data to be output to the communication network via said data port.

25. The power management system of claim 24, wherein said microprocessor enables at least one of said one or more operational parameters to be modified based on said collected performance data output from said data port.

26. A method of managing the power supplied to an appliance via a microprocessor controlling at least two load devices, the microprocessor maintaining a data port for communicating with a network, the method comprising the steps of: maintaining at the microprocessor at least one operational parameter for controlling the performance of the at least two load devices; detecting at the microprocessor when the alternating current of the power supplied to the appliance crosses the zero voltage threshold; detecting the amount of current drawn at each of the at least two load devices; controlling the average voltage applied to the at least two load devices based upon when the alternating current crosses the zero voltage threshold such that the total amount of current consumed by the at least two load devices does not exceed the value associated with said operational parameter; and modifying said operational parameter maintained by the microprocessor via the data port.

27. The method of managing the power in an appliance of claim 26, including the steps of: associating a timer with each of the at least two load devices for controlling the average voltage applied to each of the at least two load devices; determining the amount of current consumed by one of said at least two load devices; inputting the amount of current consumed by one of said at least two load devices to the microprocessor; varying the average voltage applied to the at least two load devices based upon the current consumed by the one of said at least two load devices as identified at said determining step, whereby said average voltage to be applied to the at least two load devices being determined by a table of average voltages associated with a time said timer turns the current on to each of said at least two load devices.

28. The method of managing the power in an appliance of claim 26, further comprising: collecting performance data associated with the operation of the appliance.

29. The method of managing the power in an appliance of claim 28, further comprising: downloading said performance data from the appliance via the data port; and modifying said at least one operational parameter based on performance data obtained at said downloading step.

30. The method of managing the power in an appliance of claim 29, further comprising: uploading said modified at least one operational parameter to the appliance via the data port.

31. A power management system for processing an alternating electrical current supplied to an appliance configured to communicate with a communication network, said system comprising: a zero cross detector circuit to generate an output indicating when the alternating current crosses a zero voltage threshold; at least two load devices; a microprocessor maintaining one or more operational parameters for controlling the performance of said at least two load devices, said microprocessor configured to receive the output from the zero cross detector circuit and to generate an output to control the voltage applied to each of said at least two load devices; and a data port coupled to said microprocessor, said data port configured to be associated with the communication network, wherein said operational parameters maintained by said microprocessor may be changed via said data port; wherein said microprocessor controls the voltage applied to each of said at least two load devices such that the total current consumed by said at least two load devices does not exceed a pre-determined level, and said microcontroller is configured to collect performance data associated with the operation of the appliance, said microprocessor enabling at least one of said one or more operational parameters to be modified based on said collected performance data output from said data port.
